(19) United States
(12) Patent Application Publication
(10) Pub. No.: US 2025/0338004 A1
(43) Pub. Date: Oct. 30, 2025

(54) IMAGE ACQUISITION METHOD, APPARATUS, ELECTRONIC DEVICE AND STORAGE MEDIUM

(71) Applicant: Shenzhen Oceanwing Smart Innovations Technology Co., Ltd, Shenzhen (CN)

(72) Inventors: Zechao He, Shenzhen (CN); Jia Liu, Shenzhen (CN)

(21) Appl. No.: 18/650,827

(22) Filed: Apr. 30, 2024

(51) Int. Cl. H04N 23/61; G06T 7/20; G06T 7/70; G06V 10/764

(52) U.S. Cl. CPC H04N 23/61; G06T 7/20; G06T 7/70; G06V 10/764; G06T 2207/30241; G06V 2201/07

(57) ABSTRACT

Examples of the present application relate to an image acquisition method, apparatus, electronic device, and storage medium, the method comprising: acquiring a first target image of a target scene captured by a first camera; determining, based on the first target image, an enabling probability of a second camera to capture a second target image of the target scene; and determining, based on the enabling probability and a predetermined first probability threshold, whether or not to enable or activate the second camera to capture the second target image of the target scene. As a result, the function of enabling a second camera associated with the first camera can be automatically triggered, and the accuracy of triggering the enabling of the second camera can be improved.

### FIELD

The present application relates to the field of computer technology and in particular, to an image acquisition method, an apparatus, an electronic device and a storage medium.

### BACKGROUND

In conventional technologies, some scenarios naturally require multi-location and multi-angle surveillance. For example, in home security scenarios, if there are concerns about strangers wandering from the front yard to the front door, then to the side yard and finally to the back yard, and searching for security vulnerabilities, it is necessary to install cameras to obtain recordings (e.g., videos) at key entry locations, such as the front yard, the front door, the side yard, and the back yard. However, in the aforementioned scenarios, the cameras operate independently to be passively triggered and the cameras record separately with no interactions between the cameras. Only after the user manually creates a linkage policy, and if the corresponding policy is satisfied, the linkage between cameras can be realized.

It is evident that how to automatically trigger the linkage or correlation among the cameras is a technical issue that deserves attention.

### SUMMARY

In view of the above and to solve some or all of the above technical problems, examples of the present application provide an image acquisition method, an apparatus, an electronic device, and a storage medium.

In a first aspect, examples of the present application provide an image acquisition method, the method comprising:

Acquiring a first target image of a target scene captured by a first camera;

Determining a probability of enabling (e.g., activating) a second camera to capture a second target image of the target scene based on a first target image;

Determining whether to enable the second camera to capture the second target image of the target scene based on the probability of enabling and a predetermined first probability threshold. After determining the probability of enabling exceeding the first probability threshold, enabling the second camera to capture the second target image of the target scene. Here, enabling the second camera include triggering or activating the second camera to capture an image (e.g., the second target image of the target scene).

In an example, the image acquisition method further comprises:
generating, based on the first target image, movement trajectory information of a target object in the target scene;

Enabling the second camera step is further based on a determination that a similarity between a trajectory represented by the moving trajectory information and a trigger trajectory is greater than or equal to a predetermined similarity threshold and, that the probability of enabling is greater than or equal to the predetermined first probability threshold.

In an example, wherein enabling the second camera further comprises:
determining positional information of a target object within a shooting range of the first camera;
based on the positional information, determining moment of enabling the second camera; and
enabling the second camera step is further based on the moment of enabling.

In an example, the first probability threshold is determined in the following manner:

Determining a first number of occurrences of a reference object within a shooting range of the first camera during a first time period;

Determining a second number of occurrences of the reference object moving from the shooting range of the first camera into a shooting range of the second camera during a second time period, wherein the first time period comprises the second time period, and wherein a duration of the second time period is less than a duration of the first time period;

The quotient of the second number of occurrences with the first number of occurrences is determined as the first probability threshold.

In an example, after enabling the second camera to capture the second target image of the target scene, determining whether a target object is included in the second target image captured by the second camera;

Controlling the first camera to enter a standby hibernation mode in the event that the second target image captured by the second camera includes the target object.

In an example, the method further comprises:

After enabling the second camera to capture the second target image of the target scene, using a probability determination model to determine a target probability, wherein the target probability represents a probability that the first target image captured by the first camera and the second target image captured by the second camera contain a same target object;

In the event that the target probability is less than a pre-determined second probability threshold and, furthermore, after determining that the first target image captured by the first camera and the second target image captured by the second camera comprise the same target object, employing the first target image captured by the first camera and the second target image captured by the second camera to continue to train the probabilistic determination model.

In an example, the method further comprises:

Recognition of target objects in a plurality of target images captured by the first camera and the second camera;

In accordance with the recognition results, the captured target images are classified so that each class contains target images containing a same target object;

Causing display of each class of target images;

In the event that a selection operation is detected for a particular class of target images, splicing the particular class of target images in an order of moment of acquisition to generate a target video.

In a second aspect, examples of the present application provide an image acquisition device, the device comprising:

An acquisition unit for acquiring a first target image of a target scene captured by a first camera;

A first determining unit for determining a probability of enabling a second camera to capture a second target image of the target scene based on the first target image;

A control unit for determining whether to enable the second camera to capture the second target image of the target scene based on the probability of enabling and a predetermined first probability threshold.

In an example, after enabling the second camera, the control unit further causes:
generating, based on the first target image, movement trajectory information of a target object in the target scene;
wherein enabling the second camera to capture the second target image of the target scene is based on that a similarity between a trajectory represented by the moving trajectory information and a trigger trajectory is greater than or equal to a predetermined similarity threshold and, that the probability of enabling the second camera is greater than or equal to a predetermined first probability threshold.

In an example, the device further comprises:

A third determining unit for determining positional information of the target object within a shooting range of the first camera after the second camera is enabled to capture the second target image of the target scene;

A fourth determining unit for determining a moment of enabling the second camera based on the positional information;

The control unit for enabling the second camera at the enabling moment.

In an example, the determined first probability threshold is determined in the following manner:

Determining a first number of occurrences of a reference object within a shooting range of the first camera during a first time period;

Determining a second number of occurrences of the reference object moving from the shooting range of the first camera into a shooting range of the second camera during a second time period, wherein the first time period comprises the second time period, and wherein a duration of the second time period is less than a duration of the first time period;

The quotient of the second occurrences and the first occurrences is determined as a first probability threshold. For example, the quotient may be obtained through dividing the second number of occurrences by the first number of occurrences.

In an example, the device further comprises:

A fifth determining unit for determining whether the target object is included in the second target image captured by the second camera after that the second camera is enabled to capture the second target image of the target scene; and

The control unit for controlling the first camera to enter a standby hibernation mode in the event that the second target image captured by the second camera includes the target object.

In an example, the device further comprises:

A sixth determining unit for determining a target probability using a probability determining model in case that the second camera is enabled to capture a target image of the target scene, wherein the target probability denotes a probability that the first target image captured by the first camera and the second target image captured by the second camera contain the same target object; and

A training unit for continuing to train the probabilistic determination model using the first target image captured by the first camera and the second target image captured by the second camera in the event that the target probability is less than a pre-determined second probability threshold and, moreover, the first target image captured by the first camera and the second target image captured by the second camera comprise the same target object.

In an example, the device further comprises:

A recognition unit for recognizing a target object in a plurality of target images captured by the first and second cameras;

A classification unit for classifying the plurality of target images in accordance with the recognition results so that each class of target images contain target images having a same target object;

A display unit for displaying each class of target images; and

A generating unit for stitching or splicing a particular class of target images in an order of moment of acquisition to generate a target video in the event that a selection operation is detected for the particular class of target images.

In a third aspect, examples of the present application provide an electronic device comprising:

One or more processors, and memory having executable instructions that, when executed by the one or more processors, cause the electronic device to perform the steps in the method of any of the examples of the image acquisition method of the first aspect of the present application described above.

In a fourth aspect, examples of the present application provide a computer-readable storage medium having a computer programme stored thereon, the computer programme, when executed by a processor, implementing a method such as any of the examples of the method of image acquisition of the first aspect described above.

In a fifth aspect, examples of the present application provide a computer programme, the computer programme comprising computer-readable code which, when the computer-readable code is run on a device, causes a processor in the device to implement a method such as the method of any of the examples of the method of image acquisition of the first aspect described above.

An image acquisition method provided by examples of the present application can acquire a first target image of a target scene captured by a first camera, after which, based on the first target image, an probability of enabling a second camera to capture a second image of the target scene is determined, and then, based on the probability of enabling and a pre-determined first probability threshold, whether or not to enable the second camera to capture the second target image of the target scene is determined. Thereby, the probability of enabling the second camera can be determined based on the first target image of the target scene captured by the first camera, and a determination may be made as to whether to enable the second camera to capture the second target image of the target scene. In this way, the function of enabling and capturing images of the second camera associated with the first camera can be automatically triggered, and, the accuracy of triggering the enabling of the second camera can be improved.

### BRIEF DESCRIPTION OF THE DRAWINGS

FIG. 1 shows a flow diagram of an image acquisition method provided by an example of the present application;

FIG. 2 shows a flow diagram of another image acquisition method provided by examples of the present application;

FIG. 3 shows a flow diagram of another image acquisition method provided by examples of the present application;

FIG. 4 shows a schematic diagram of an image acquisition device provided by an example of the present application;

FIG. 5 is a schematic diagram of an electronic device provided by an example of the present application.

### DETAILED DESCRIPTION

Various exemplary examples of the present application will now be described in detail with reference to the accompanying drawings. It should be noted that the relative arrangements, numerical expressions and values of the components and steps set forth in these examples do not limit the scope of the present application unless otherwise specifically stated.

It is understood by those skilled in the art that the terms “first”, “second” and the like in the examples of the present application are only used to differentiate between different steps, devices, modules and other objects, and do not represent any particular technical meaning or indicate a logical order among them.

It should also be understood that, in this example, “plurality” may refer to two or more, and “at least one” may refer to one, two or more.

It should also be understood that any of the components, data, or structures referred to in examples of the present application may generally be understood to be one or more in the absence of an express limitation or contrary revelation given before or after.

In addition, the term “and/or” in the present application is merely a description of an association relationship of the associated objects, and indicates that three kinds of relationships may exist, for example, A and/or B, which may be indicated as: the existence of A alone, the existence of both A and B, and the existence of B alone. In addition, the character “/” in the present application generally indicates that the associated objects are in an “or” relationship.

It should also be understood that the description of the various examples in the present application highlights the differences between the various examples, and that their similarities or likenesses can be cross-referenced and will not be repeated for the sake of brevity.

The following description of at least one exemplary example is in fact merely illustrative and in no way serves as any limitation on the present application and its application or use.

Techniques, methods and apparatus known to those of ordinary skill in the relevant field may not be discussed in detail, but where appropriate, the techniques, methods and apparatus should be considered part of the specification.

It should be noted that similar labels and letters denote similar items in the accompanying drawings below, so that once an item is defined in an accompanying drawing, it does not need to be discussed further in subsequent accompanying drawings.

It is to be noted that the examples and the features in the examples in the present application may be combined with each other without conflict. To facilitate the understanding of the examples of the present application, the present application will be described in detail below with reference to the accompanying drawings and in conjunction with the examples. Obviously, the described examples are a part of the examples of the present application and not all of the examples. Based on the examples in this application, all other examples obtained by a person of ordinary skill in the art without making creative labour fall within the scope of protection of this application.

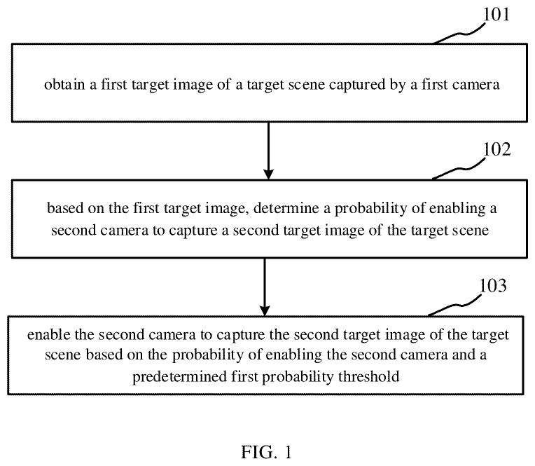

FIG. 1 shows a flow diagram of an image acquisition method provided by an example of the present application. As shown in FIG. 1, the method specifically comprises:

Step 101, acquiring a first target image of a target scene captured by a first camera.

The first camera, in this example, may be any camera for capturing an image of the target scene (e.g., a first target image).

The target scene, may be any scene. As an example, the target scene may be a home security scene.

The first target image, may be an image of the target scene captured by the first camera.

In practice, the first camera may continuously acquire a plurality of first target images of the target scene. Alternatively, the first camera may acquire the first target image of the target scene when a preset trigger condition is satisfied.

Step 102, based on the first target image, determining a probability of enabling (e.g., activating) a second camera.

In this example, a ReID (Re-identification) model may be used to determine the probability of enabling the second camera based on the first target image.

Specifically, a first target image, may be input to a pre-trained ReID model to obtain a probability that a person contained in that first target image is the same person contained in a reference image. The obtained probability is determined as the probability of enabling the second camera. The ReID model, as described above, can be used to calculate the probability that the person contained in the first target image is the same person contained in the reference image.

Step 103, determining whether to enable the second camera to capture a second target image of the target scene based on the probability of enabling the second camera and a predetermined first probability threshold.

In this example, the second camera may be enabled to capture a second target image of the target scene if the probability of enabling is greater than or equal to the predetermined first probability threshold. If the probability of enabling is less than the first probability threshold, there is no need to enable the second camera to capture the second target image of the target scene.

An image acquisition method provided by examples of the present application can acquire a first target image of a target scene captured by a first camera, after which, based on the first target image, a probability of enabling the second camera is determined, and then, based on the probability of enabling and a pre-determined first probability threshold, a determination is made as to whether or not to enable the second camera to capture a second target image of the target scene. Thereby, the probability of enabling the second camera can be determined based on the first target image of the target scene captured by the first camera, and then a determination is made as to whether to enable the second camera to capture the second target image of the target scene. In this way, the function of enabling and capturing images of the second camera associated with the first camera can be automatically triggered, and, the accuracy of triggering the enabling of the second camera can be improved.

In some optional implementations of this example, the first probability threshold, may be determined in the following manner:

Firstly, a first number of occurrences of a reference object within a shooting range of the first camera during a first time period is determined.
wherein the first number of occurrences may be a number of times that the reference object appears within a shooting range of the first camera during the first time period.

Afterwards, a second number of occurrences of the reference object moving from the shooting range of the first camera into a shooting range of the second camera during a second time period is determined.
wherein the first time period includes the second time period, and wherein the second time period has a duration that is less than a duration of the first time period. As an example, the first time period, may be a time period having a duration of a predetermined duration (e.g. 14 days). The second time period, may be a time period with a duration of 3 minutes (or other duration) within the time period of the first time period (e.g. 14 days).

The second number of occurrences may be a number of times during the second time period that the reference object enters the shooting range of the second camera from the shooting range of the first camera.

The quotient of the second number of occurrences and the first number of occurrences is then determined as a first probability threshold.

It is to be understood that in the optional implementation described above, the first probability threshold can be calculated by the first number of occurrences and the second number of occurrences, such as dividing the second number of occurrences by the first number of occurrences, whereby the accuracy of triggering the second camera enablement can be further improved.

In some optional implementations of this example, after performing the above step 103, the following steps may also be performed:

First, after the second camera is enabled to capture the second target image of the target scene, determining whether the target object is included in the second target image captured by the second camera.

Here, a ReID (Re-identification) model may be used to determine a probability that the second target image captured by the second camera includes a target object, and then determine whether the target object is included in the second target image captured by the second camera by judging the magnitude of the relationship between the probability and a predetermined threshold.

Thereafter, controlling the first camera to enter a standby hibernation mode in the event that the second target image captured by the second camera includes the target object.

It is to be understood that in the above optional example, in case it is determined that the target object included in the second target image captured by the second camera represents the same object included in the first target image captured by the first camera, the first camera may be caused to enter into a standby hibernation mode in order to save power consumption of the first camera.

In some optional implementations of this example, after performing the above step 102, the following steps may also be performed:

Firstly, after the second camera is enabled to capture the second target image of the target scene, a predetermined probability determination model is used to determine the target probability.
wherein the target probability denotes a probability that the first target image captured by the first camera and the second target image captured by the second camera contain the same target object.

As an example, the aforementioned predetermined probability determination model, may be a ReID model.

Thereafter, in the event that the target probability is less than a pre-determined second probability threshold and, furthermore, the first target image captured by the first camera and the second target image captured by the second camera comprise the same target object, training of the probabilistic deterministic model is continued using the first target image captured by the first camera and the second target image captured by the second camera.

In practice, the probabilistic deterministic model may use images captured in various situations, such as: a low light situation at night, where camera A is outdoors and captures color images due to a porch light illumination, while camera B is indoors and captures black-and-white images due to the lack of light. When a same person (e.g., a stranger or a family member) moves from outdoors to indoors, the ReID algorithm struggles to recognize them as the same person because of significant differences in lighting and imaging between the two cameras. However, the images captured by camera A and camera B are actually of the same person. Therefore, the target image captured in the above scenario can be added to the feature library of ReID target to improve the accuracy of subsequent determination of the target probability.

It is to be understood that in the above optional example, the probability determination model may continue to be trained using the first target image captured by the first camera and the second target image captured by the second camera in the case where the target probability is less than a pre-determined second probability threshold and where the first target image captured by the first camera and the second target image captured by the second camera actually comprise the same target object so as to enhance the probability determination model's accuracy of the subsequent determination of the target probability.

In some optional implementations of this example, after performing the above step 103, the following steps may also be performed:

Firstly, the target object in the captured target images by the first and second cameras is recognized.

Afterwards, the captured target images are classified in accordance with the recognition results so that each class of target images contain target images having a same target object.

Then, target images of each class are displayed.

Finally, in the event that a selection operation is detected for a particular category of target images, the particular category of target images are spliced in an order of corresponding moment of acquisition to generate a target video.
wherein the target video may be a video generated by stitching or splicing the individual classes of target images in the order of the corresponding moment of acquisition.

Specifically, after classifying the captured target images, thumbnails of the target images of each class may be displayed. For each class of target images, there may correspond to a set of segments, and each segment corresponds to a record of the starting and ending moments at which the target object appears in the segment. As a result, when the user selects the target object (i.e., the selection operation described above) and clicks on one-key search, the first frame and timestamp information of the target object in different segments can be obtained and displayed in a search result list. When the user clicks on one-click play, multiple clips can be stitched together in the order of their corresponding timestamps, and a 3D image of, for example, a house yard can be generated and presented. When users click on download, a spliced video can be generated for the users to download. When the user clicks on Share, a URL (Uniform Resource Locator) is generated and copied to a pasteboard for easy sharing. When users view the relevant spliced video, if they find any splicing errors, they can provide feedback on the video and relevance information through quick feedback of the splicing errors.

It may be understood that in the above optional implementation, target images of the same class may be spliced according to the corresponding order of the moment of acquisition in order to generate a target video. This in turn enables operations such as sharing, downloading, and viewing of the target video.

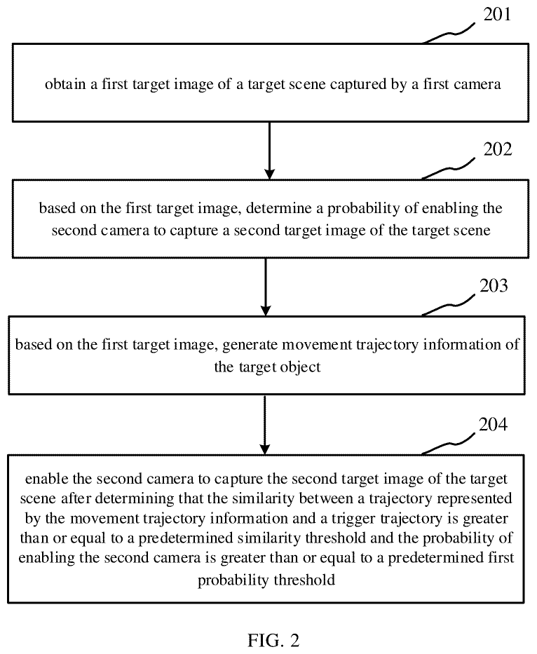

FIG. 2 shows a flow diagram of another image acquisition method provided by examples of the present application. As shown in FIG. 2, the method specifically comprises: Step 201, acquire a first target image of a target scene captured by a first camera.

In this example, step 201 is substantially the same as step 101 in the corresponding example of FIG. 1, and will not be repeated here.

Step 202, based on the first target image, determining a probability of enabling the second camera.

In this example, step 202 is substantially the same as step 102 in the corresponding example of FIG. 1, and will not be repeated here.

Step 203, based on the first target image, generating movement trajectory information of the target object.

In this example, the target object, may be any of the target objects in the first target image. As an example, the target object, may include: a person, a vehicle, an animal (e.g., a pet), etc.

Algorithms such as optical flow method, target tracking, and the like may be used to generate information about the movement trajectory of the target object based on the first target image.

Step 204, enabling the second camera to capture a second target image of the target scene in the event that the similarity between a trajectory represented by the movement trajectory information and a trigger trajectory is greater than or equal to a predetermined similarity threshold and, furthermore, the probability of enabling the second camera is greater than or equal to a predetermined first probability threshold.

In this example, the similarity between the trajectory represented by the mobile trajectory information and the triggering trajectory can be calculated using at least one of the following: closest-pair Distance (Closest Neighbour Pair), Sum-of-Pairs Distance (Pairwise Summation Algorithm), DTW (Dynamic Time Warping), LCSS (Longest Common Subsequence, Longest Common Subsequence algorithm), etc.

In this example, the trigger trajectory is used to trigger enabling the second camera.

It is to be noted that, in addition to the above-documented contents, the present example may also include the corresponding technical features described in the corresponding example of FIG. 1, and thereby realize the technical effect of the image acquisition method shown in FIG. 1, please refer to the relevant description of FIG. 1 for a concise description, which will not be repeated herein.

In the image acquisition method provided by examples of the present application, in the case where the similarity between the trajectory represented by the movement trajectory information and the triggering trajectory is greater than or equal to a predetermined similarity threshold, and, furthermore, the probability of enabling is greater than or equal to a pre-determined first probability threshold, it can usually be indicated that the target object is about to enter a shooting range of the second camera, and thus triggers the activation of the second camera at the aforementioned timing can further improve the accuracy of triggering the second camera activation.

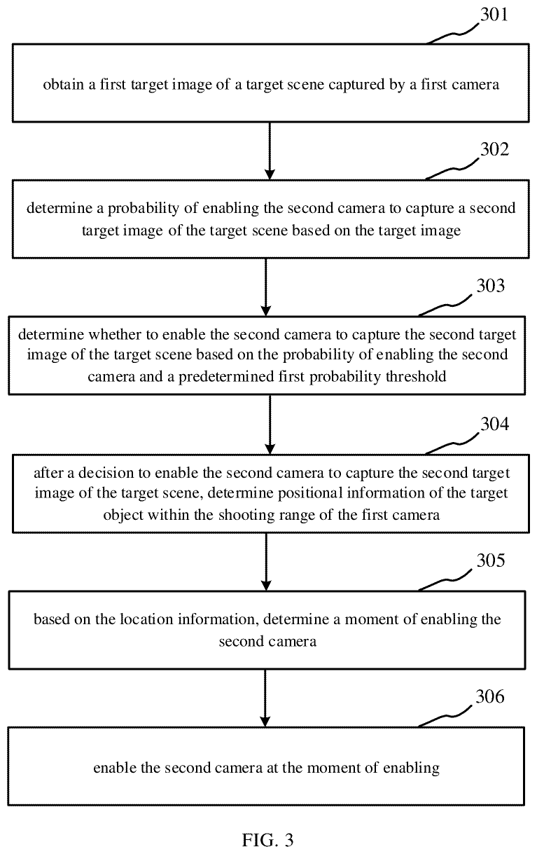

FIG. 3 shows a flow diagram of yet another image acquisition method provided by examples of the present application. The present method may be applied to one or more electronic devices such as a smartphone, a laptop computer, a desktop computer, a portable computer, a server, and the like. In addition, the execution subject of the present method may be hardware or software. When the above-described execution subject is hardware, the execution subject may be one or more of the above-described electronic devices. For example, a single electronic device may execute the present method, or a plurality of electronic devices may cooperate with each other to execute the present method. When the above-described execution subject is software, the present method may be implemented as a plurality of software or software modules, or may be implemented as a single software or software module. No specific limitation is made herein.

Specifically, as shown in FIG. 3, the method comprises:

Step 301, acquiring a first target image of a target scene captured by a first camera.

In this example, step 301 is substantially the same as step 101 in the corresponding example of FIG. 1, and will not be repeated here.

Step 302, determining a probability of enabling a second camera based on the first target image.

In this example, step 302 is substantially the same as step 102 in the corresponding example of FIG. 1, and will not be repeated here.

Step 303, determining whether to enable the second camera to capture a second target image of the target scene based on the probability of enabling the second camera and a predetermined first probability threshold.

In this example, step 303 is substantially the same as step 103 in the corresponding example of FIG. 1, and will not be repeated here.

Step 304, after the second camera is enabled to capture the second target image of the target scene, determining positional information of the target object within a shooting range of the first camera.

The positional information, in this example, may indicate the position of the target object within the shooting range of the first camera.

Step 305, based on the positional information, determining an moment of enabling the second camera.

In this example, a correspondence between the position indicated by the positional information and the moment of enabling the second camera may be predetermined, after which the moment of enabling the second camera is determined based on the correspondence and the positional information.

Step 306, enabling the second camera at the moment of enabling.

In this example, for example, if the positional information indicates that the target object is located in a frame coordinate region [x,y] of the first camera, the second camera may be enabled after a predetermined length of time (e.g., 4 seconds) from the current moment.

The following is an exemplary description of the examples of the present application, but it should be noted that the examples of the present application may have the features described below, but the following description does not constitute a limitation of the scope of protection of the examples of the present application.

Here, if the same event spans across multiple neighboring cameras (e.g., the target object moves from the shooting range of the first camera to the shooting range of the second camera) and triggers the activation and recording of multiple cameras, the phenomenon can be referred to as a cross-camera event.

The ReID algorithm, which can be used for searching, recognizing and localizing the same target (i.e., the aforementioned target object) in different segments.

Ambient semantic segmentation algorithms can segment an image (i.e., the target image described above) into blocks of regions with certain semantic meanings and identify the semantic category of each block.

A main scheduling device can be selected from multiple camera systems. The main scheduling device may have the following characteristics: constantly powered, NPU (Neural-Network Processing Unit) greater than or equal to 0.5 TOPS (Tera Operations Per Second), upstream and downstream network bandwidth greater than or equal to 2 Mbps (Million bits per second). If there is no suitable local side device meeting the above characteristics, the main scheduling device may be selected from the cloud. The main scheduling device can aggregate target feature information from various correlated cameras.

Here, in terms of hardware and algorithm design for cross-camera linkage, the system hardware and algorithm configuration can be adopted as follows:

First, each camera (including the first camera and the second camera described above) may have one or more chips capable of detecting orientation and distance, including but not limited to UWB (Ultra Wide Band), Bluetooth, WiFi (WIreless Fidelity, wireless communication technology), ZigBee, radar and other technologies. This detection angle is located 180° behind the camera's field of view, with vertical and horizontal orientation accuracy up to 1°, the maximum detection distance of 10 meters, and an accuracy of 0.5 meters. Through this orientation and distance detection, the system obtains the relative position and distance between each pair of cameras.

In addition, the App (e.g., application) used in conjunction with the camera provides ten 3D images of typical houses and yards, allowing users to rotate and tilt the 3D images of the house and yard for a 360° view. User can select a design plan of the house, drag the camera to simulated installation positions, and set the monitoring orientation.

As a result, using the camera's relative position detection algorithm, the system can determine the relative distance and angle of each camera, and the monitoring angle and orientation.

In addition, the camera may have a CPU (Central Processing Unit) or an NPU (Neural-Network Processing Unit) capable of running an environment for semantic segmentation algorithms to segment environmental backgrounds such as lawns, green plants, paths, walls, doors, fences, and the like. Moreover, visual detection and trajectory algorithms for objects such as people, cars, pets and bags can be executed based on consecutive frames to confirm the presence of one or more objects such as people, cars, pets and so on in the frame, and to generate the trajectory heatmap of real actions.

As a result, using the environmental semantic segmentation algorithm, the system can determine the environmental background in the field of view of each camera, isolate key information, such as public roads, front and back yards, courtyard paths, car parks, and porches, and preset monitoring priorities, such as assigning low monitoring priority for public roads, assigning medium priority for front and back yards and courtyard paths, and assigning high priority for car parks and porches. The system may detect the presence of target objects in the current event, such as people, cars, pets and bags, the degree of overlap with the background of the environment, the direction of movement, the trajectory of movement, and the coordinates of the area when leaving the screen, so as to exclude the environmental false triggers, and triggers with a low priority, to record the movement trajectory of the target objects, and to generate the heat map of the trajectory.

Cross-camera correlation big data can be collected in the following way: based on the results of the above target (i.e. the above target object) detection and tracking algorithms (i.e. the above trajectory heat map), the cross-camera triggering time sequence, and the target consistency, the correlation big data can be modelled to obtain a probability that an event should be triggered from Camera A to Camera B (i.e. the probability of the second camera being activated as described above).

Wherein the features of the above modelling event may include:

1. Event elements: target objects, such as people, cars and pets, and these three types of targets are capable of moving autonomously.

2. Event movement trajectory feature modelling: the direction of movement in the environmental background, the movement trajectory, the coordinates of the area when leaving the screen, determining the degree of overlap within a preset time period (e.g., 14 days), and generating aggregated feature values.

3. Cross-camera correlation modelling: camera A (i.e. the first camera mentioned above) is triggered first, and camera B (i.e. the second camera mentioned above) is triggered later, both within x seconds (e.g., x is configurable and preset to 120 seconds). Based on the detection results of ReID (Pedestrian Identification) and VehicleID (Vehicle Identification), it is determined that the target appears both in Camera A and Camera B within a timeframe of x seconds (e.g., x is configurable and preset to 120 seconds). A degree of overlapping within this preset time period is then assessed, and aggregated feature values are generated.

Here, the following method can be used to calculate a probability of an event that meets the above-described characteristics cross-scanning from camera A to camera B (i.e., the above-described first probability threshold). The numerator is: a number of recordings that match the cross-camera correlation during the aforementioned preset time period, i.e. the aforementioned first number of occurrences. The denominator is: a total number of recordings from camera A during the above predetermined time period, i.e., the above second number of occurrences.

The following calibration mechanism is triggered when a change in orientation and distance between cameras exceeds the thresholds, e.g., the default orientation threshold of 30° and the default distance threshold of 2 meters.
1. Under the calibration mechanism, priority is given to verifying the correlation of the actual triggering events over a 3-day period according to the original linkage rules as follows:
i. The area of the target along the picture trail.
ii. Moving from left to right.
iii. Passing through the camera A screen coordinate area [x,y].
iv. After 4 seconds, Camera B (e.g., the second camera above) will be triggered.
2. If there is only one deviation from the conditions above and the other conditions are met, the linkage rules will be calibrated based on the actual triggering events of the 3-day period.
3. If two or more of conditions are not met, re-initiate big data modelling of cross-camera correlations.

Further, the cross-camera linkage may be used to enable early activation and recording of the associated camera.

Determining a probability of cross-camera correlation: when the probability exceeds y (e.g., y is configurable and preset to 80%), camera A immediately sends start and record commands to camera B when it satisfies the trigger feature.

Execution of the cross-camera command: when the target movement trajectory meets the event characteristics and satisfies the correlation probability threshold, camera B is triggered to start recording in advance.

Cross-camera lead time modelling and correction can be done in the following way:

First, obtain a timestamp of when the target left camera A and a timestamp of when the relevant human, vehicle or pet appeared in camera B.

Subsequently, a position and a size of the target at camera B are obtained.

Then, preset z seconds of advance value (z is obtained from cross-camera lead time modelling and correction, which is preset to 2 seconds, with an increment/decrement step of 1 second), detect the correlation video of the following 3 days. If the target appears closer to an edge of the screen (indicating that the target is about to leave), with a smaller size, and a proportion of more than 80%, it indicates that the advance value is reasonable, and we can continue to try to advance further; if the target doesn't appear, and the event is determined to be a false trigger with a probability exceeding 50%, then the advance value is too aggressive and needs to be retracted.

Further, the camera A is triggered to enter a standby hibernation mode when the human-vehicle features appearing in the camera B are consistent with those appearing in the camera A.

In addition, the spatial-temporal correlation of the cameras may be used to compensate for the correlation ability of the ReID algorithm in scenes with large differences in images. Specifically, the clip recording of each camera may contain the spatial-temporal correlation information described above, including an upstream device, a downstream device, and a timestamp in the triggering sequence. The respective cameras operate the ReID feature extraction algorithm to obtain target object feature information based on a single video clip, including the number of targets, respective feature attributes and feature values, and the start and end appearance timestamps of the targets. A main scheduling device, which may be selected from a plurality of camera systems. The main scheduling device may have the following characteristics: constantly powered, NPU greater than or equal to 0.5 TOPS, upstream and downstream network bandwidth greater than or equal to 2 Mbps, and if there is no suitable local-side device meeting these characteristics, the main scheduling device may be selected from the cloud. The main scheduling device can aggregate target feature information from various correlated cameras.

In addition, cross-camera linkage and video recording may be applied to generate an ensemble video through the spatial-temporal correlation of the recordings and the ReID algorithm. The main scheduling device generates an index, which may contain the following information: a thumbnail image of the target; a set of clips with correlation and the start and end times of the target's appearance in each clip; timestamp information of the target's appearance in each clip; when the user selects the target and clicks a one-key search, the main scheduling device acquires the first frames of the target in the different clips and the timestamp information, which is displayed in a list of search results; when the user clicks one-button play, the main scheduling device splices multiple clips in the order of the timestamps, and generates time and 3D icons based on houses and yards to present the corresponding video; when the user clicks download, the main scheduling device generates a new spliced video for the user to download; when the user clicks share, the URL is generated and copied to the pasteboard, which is easy for the user to share it to social media platforms; when the user views the relevant spliced video, the spliced video can be viewed through the splicing errors; when the user views the related spliced video, the user can provide feedback on the video and relevance information through the quick feedback of splicing error.

A cross-camera serial video playback can be achieved in the following manner: when playing the cross-camera associated recording sequence, a three-dimensional panoramic map is used to restore the cross-border movement overall trajectory and the trajectory point currently in playback, and the user can directly click on the three-dimensional panoramic trajectory to jump to view the content that the user wants to see. A three-dimensional panoramic view of a house can be obtained based on the above method of obtaining a live view of the house, and the predefined house types of the App can be viewed in left and right pitch and in sub-floor view, and the house types imported by the user can be viewed in left and right pitch. The actual position of each camera can be obtained based on a user-defined device position, such as a front door camera being in the middle of the front of the panorama, which is set to the left side of the front of the panorama. Based on the sequence of activities of an active object (e.g., a person/animal) across the camera, the sequence of its activities is plotted on the 3D panorama to restore the overall activity trajectory. A marker (e.g. a red dot, but not limited to this form of marker) is given to each location where the object has been active. The markers are marked with lighter colours for the positions or locations where the activity occurs further away from the present time; the markers are marked with darker colours for the positions or locations where the activity occurs closer to the present time. Lines connect different locations, marking the trajectory of the activity of this object and the time sequence. When there are multiple floors, the system marks which floors the object has visited, and draws the trajectory across floors. The system highlights a point of the currently playing activity trajectory on an overall activity trajectory of the 3D panorama. The system marks the spatial and temporal relationship of the current activity in the entire cross-camera activity. In the player page, users can zoom in to see the trajectory view of the 3D restoration, or click on a trajectory point inside the 3D panorama to jump directly to the video they want to see, and query what this object is doing at this location at this moment.

As a result, the cross-camera linkage rules based on spatial-temporal correlation of this solution can trigger the activation of the correlated cameras more precisely, thus making the whole-house monitoring via cameras (e.g., the battery-powered cameras) more rapid and comprehensive. Users do not need to manually measure and set up cumbersome linkage rules, which greatly simplifies the steps for users to set up the system. There is also no need to manually calibrate the device when changing locations, making the system smarter and reducing the difficulty for users to deploy and set up the security system. Combining the spatial and temporal correlation of cross-camera recording with ReID feature correlation, it improves the correct convergence rate and solves the problem of convergence failure caused by great difference in imaging quality of cross-device images. Cross-camera linkage achieves early activation and recording of related or correlated cameras. The spatial-temporal correlation of cameras makes up for the correlation ability of ReID algorithm in scenes with large differences in images. The spatial and temporal correlation of video recording and ReID algorithm can be used to generate an ensemble video.

It is to be noted that, in addition to the above-documented contents, the present examples may also include the technical features described in the above examples, and thereby achieve the technical effects of the image acquisition method shown above, which are referred to in the above description for a concise description, and will not be repeated herein.

The image acquisition method provided by examples of the present application determines the moment of enabling of the second camera by the position information of the target object within the shooting range of the first camera, whereby the accuracy of triggering the enabling of the second camera can be further improved.

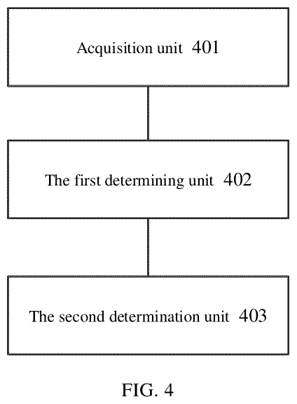

FIG. 4 shows a schematic diagram of a structure of an image acquisition device provided by an example of the present application. Specifically included:

Acquisition unit 401 for acquiring a first target image of a target scene captured by a first camera;

A first determining unit 402 for determining a probability of enabling a second camera based on the first target image;

A second determination unit 403 for determining whether to enable the second camera to capture a second target image of the target scene based on the probability of enabling the second camera and a predetermined first probability threshold.

Optionally, the image acquisition device includes an enabling unit (not shown in the figure) for enabling the second camera to capture the second target image of the target scene based on the probability of enabling exceeding the predetermined first probability threshold.

In a possible example, enabling the second camera comprises:

Generating, based on the first target image, movement trajectory information of a target object in the target scene;

Enabling the second camera to capture the second target image of the target scene in the event that a similarity between a trajectory represented by the moving trajectory information and a trigger trajectory is greater than or equal to a predetermined similarity threshold and, furthermore, that the probability of enabling is greater than or equal to the predetermined first probability threshold.

In a possible example, after enabling the second camera further comprises:

A third determination unit (not shown in the figure) for determining positional information of the target object within a shooting range of the first camera after the second camera is enabled to capture the second target image of the target scene;

A fourth determination unit (not shown in the figure) for determining a moment of enabling the second camera based on the position information;
the enabling unit (not shown in the figure) for enabling the second camera at the enabling moment.

In a possible example, the first probability threshold, is determined in the following manner:

Determining a first number of occurrences of a reference object within the shooting range of the first camera during a first time period;

Determining a second number of occurrences of the reference object moving from the shooting range of the first camera into a shooting range of the second camera during a second time period, wherein the first time period comprises the second time period, and wherein a duration of the second time period is less than a duration of the first time period;

The quotient of the second occurrences and the first occurrences is determined as the first probability threshold.

In a possible example, the device further comprises:

A fifth determining unit (not shown in the figure) for determining whether the target object is included in the second target image captured by the second camera after the second camera is enabled to capture the second target image of the target scene;

A control unit (not shown in the figure) for controlling the first camera to enter a standby hibernation mode in the event that the second target image captured by the second camera includes the target object.

In a possible example, the device further comprises:

A sixth determination unit (not shown in the figure) for determining a target probability using a predetermined probability determination model after the second camera is enabled to capture the second target image of the target scene, wherein the target probability represents a probability that the first target image captured by the first camera and the second target image captured by the second camera contain the same target object;

A training unit (not shown in the figure) for continuing to train the probabilistic deterministic model using the first target image captured by the first camera and the second target image captured by the second camera in the event that the target probability is less than a pre-determined second probability threshold and, moreover, the first target image captured by the first camera and the second target image captured by the second camera comprise the same target object.

In a possible example, the device further comprises:

A recognition unit (not shown in the figure) for recognizing the target object in the target images captured by the first and second cameras;

A classification unit (not shown in the figure) for classifying the captured target images in accordance with the recognition results so that each class of target images contain target images having the same target object;

A display unit (not shown in the figure) for displaying target images of each class;

A generating unit (not shown in the figure) for stitching a particular class of target images in an order of their moment of acquisition to generate a target video, in case a selection operation for the particular category of target images is detected.

The image acquisition device provided in this example may be an image acquisition device as shown in FIG. 4, which may perform all the steps of each of the above-described image acquisition methods, and thereby realize the technical effects of each of the above-described image acquisition methods, please refer to the above relevant descriptions for a concise description, which will not be repeated herein.

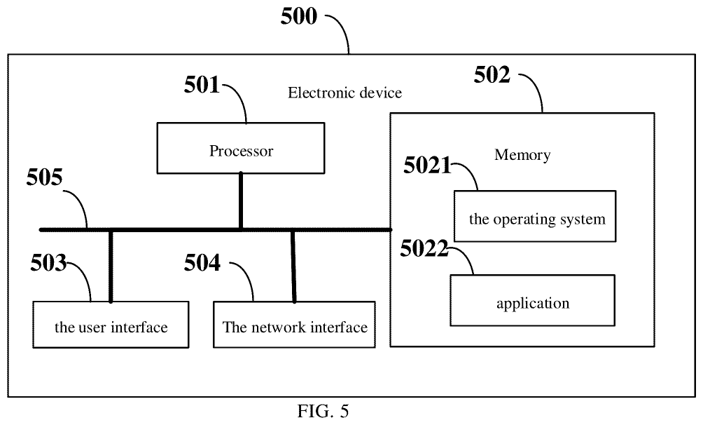

FIG. 5 is a schematic diagram of a structure of an electronic device provided by an example of the present application. The electronic device 500 shown in FIG. 5 comprises: at least one processor 501, a memory 502, at least one network interface 504, and other user interfaces 503. Various components in the electronic device 500 are coupled together via a bus system 505. It will be appreciated that the bus system 505 is used to enable connected communication between these components. The bus system 505 includes a power bus, a control bus, and a status signal bus in addition to a data bus. However, for clarity of description, the various buses are labelled as bus system 505 in FIG. 5.

Among other things, the user interface 503 may include a display, a keyboard, or a clicking device (e.g., a mouse, a trackball, a touch-sensitive pad, or a touch screen, etc.).

It will be appreciated that the memory 502 in examples of the present application may be volatile memory or non-volatile memory, or may include both volatile and non-volatile memory. Among other things, the non-volatile memory may be Read-Only Memory (ROM), Programmable Read-Only Memory (PROM), Erasable Programmable Read-Only Memory (EPROM), Electrically Erasable Programmable Read-Only Memory (EEPROM), or Electrically Erasable Programmable Read-Only Memory (EEPROM). EPROM, EEPROM), or flash memory. The volatile memory may be Random Access Memory (RAM), which is used as an external cache. By way of exemplary, but not limiting, illustration, many forms of RAM are available, such as Static Random Access Memory (SRAM), Dynamic Random Access Memory (DRAM), Synchronous DRAM (SDRAM), Double Data Rate Synchronous Dynamic Random Access DRAM, Synchronous DRAM (SDRAM), Double Data Rate SDRAM (DDRSDRAM), Enhanced Synchronous Dynamic Random Access Memory (ESDRAM), Synchronous Link DRAM (SLDRAM), and Direct Rambus Random Access Memory (DRRAM). Rambus RAM (DRRAM). The memory 502 described herein is intended to include, but is not limited to, these and any other suitable types of memory.

In some implementations, the memory 502 stores elements, executable units or data structures, or a subset of them, or an extended set of them, as follows: an operating system 5021 and an application 5022.

Wherein the operating system 5021, contains various system programs, such as a framework layer, a core library layer, a driver layer, and the like, for implementing various basic businesses as well as handling hardware-based tasks. The application 5022, containing various applications, such as a media player (Media Player), a browser (Browser), and the like, is used to implement various application businesses. Programs for implementing the methods of the examples of the present application may be included in the application 5022.

In this example, the processor 501 is used to perform the method steps provided by each method example by calling a program or instruction stored in the memory 502, specifically, a program or instruction stored in the application 5022, including, for example:

Acquiring a first target image of a target scene captured by a first camera;

Determining a probability of enabling a second camera based on the first target image;

Determining whether to enable the second camera to capture a second target image of the target scene based on the probability of enabling and a predetermined first probability threshold; and

Enabling the second camera to capture a second target image of the target scene based on the probability of enabling exceeding the first probability threshold.

The methods disclosed in the above examples of the present application may be applied in, or implemented by, the processor 501. The processor 501 may be an integrated circuit chip with signal processing capabilities. In the implementation, the steps of the above method may be accomplished by integrated logic circuits of hardware in the processor 501 or by instructions in the form of software. The above-described processor 501 may be a general-purpose processor, a Digital Signal Processor (DSP), a Special Purpose Integrated Circuit (Application Specific Integrated Circuit (ASIC)), an off-the-shelf programmable gate array (Field Programmable Gate Array (FPGA) or other programmable logic devices, discrete gate or transistor logic devices, and discrete hardware components. Various methods, steps, and logic block diagrams of the disclosure in examples of the present application may be implemented or performed. The general purpose processor may be a microprocessor or the processor may also be any conventional processor, etc. The steps of the methods disclosed in conjunction with examples of the present application may be directly embodied as being performed by a hardware decoding processor or performed with a combination of hardware and software units in the decoding processor. The software unit may be located in a random memory, flash memory, read-only memory, programmable read-only memory or electrically erasable programmable memory, registers, and other storage media well established in the art. The storage medium is located in memory 502, and the processor 501 reads the information in memory 502 and completes the steps of the above method in combination with its hardware.

It will be appreciated that these examples described herein may be implemented in hardware, software, firmware, middleware, microcode, or combinations thereof. For hardware implementations, the processing unit may be implemented in one or more Application Specific Integrated Circuits (ASICs), Digital Signal Processing (DSPs), Digital Signal Processing Devices (DSPDevices, DSPDs), Programmable Logic Devices (PLDs), Programmable Logic Devices (PLDs), Programmable Logic Devices (PLDs), Programmable Logic Devices (PLDs), and Programmable Logic Devices (PLDs). DSPD), Programmable Logic Device (PLD), Field-Programmable Gate Array (FPGA), general-purpose processors, controllers, microcontrollers, microprocessors, other electronic units used to perform the above functions of the present application, or combinations thereof.

For software implementations, the techniques described herein may be implemented by units that perform the functions described herein. The software code may be stored in a memory and executed through a processor. The memory may be implemented in the processor or external to the processor.

The electronic device provided in this example may be an electronic device as shown in FIG. 5, which may perform all the steps of each of the above-described image capturing methods, and thus achieve the technical effect of each of the above-described image capturing methods, with specific reference to the relevant descriptions above, which are described herein for the sake of brevity.

Examples of the present application also provide a storage medium (computer readable storage medium). The storage medium herein stores one or more programs. Among other things, the storage medium may include volatile memory, such as random access memory; the memory may also include non-volatile memory, such as read-only memory, flash memory, a hard disc or a solid state drive; and the memory may also include a combination of the above types of memory.

When the one or more programs in the storage medium are executable by the one or more processors to implement the above-described image acquisition method executed on the electronic device side.

The above processor is used to execute the image acquisition program stored in the memory to implement the following steps of the image acquisition method performed on the electronic device side:

Acquiring a first target image of a target scene captured by a first camera;

Determining a probability of enabling a second camera to capture a second image of the target scene based on the first target image;

Determining whether to enable the second camera to capture the second target image of the target scene based on the probability of enabling and a predetermined first probability threshold; and

Enabling the second camera to capture the second target image of the target scene based on the probability of enabling exceeding a predetermined first probability threshold.

The professional should be further aware that the units and algorithmic steps of the various examples described in conjunction with the examples disclosed herein are capable of being implemented in electronic hardware, computer software, or a combination of both, and that the composition and steps of the various examples have been described in the foregoing description in general terms according to function, in order to clearly illustrate the interchangeability of hardware and software. Whether these functions are performed in hardware or software depends on the particular application and design constraints of the technical solution. The skilled person may use different methods to implement the described functions for each particular application, but such implementations should not be considered outside the scope of this application.

The steps of the method or algorithm described in conjunction with the examples disclosed herein may be implemented with hardware, a software module executed by a processor, or a combination of both. The software module may be placed in random memory (RAM), memory, read-only memory (ROM), electrically programmable ROM, electrically erasable programmable ROM, registers, hard drives, removable disks, CD-ROMs, or any other form of storage medium known in the art.

The above-described specific examples provide a further detailed description of the purpose, technical solutions and beneficial effects of the present application, and it should be understood that the above-described specific examples are only the specific examples of the present application, and are not intended to limit the scope of protection of the present application, and any modifications, equivalent replacements, improvements, etc. made within the spirit and principles of the present application shall be included in the scope of protection of the present application. In addition, the foregoing examples are expressed as a series of action combinations for the sake of simple description, but a person skilled in the art should be aware that the present invention is not limited by the order of the described actions, because certain steps may be performed in other orders or simultaneously according to the present invention. Secondly, the person skilled in the art should also be aware that the examples described in the specification are optional examples, and the actions and modules involved are not necessarily necessary for the present invention.

What is claimed is:

1. An image acquisition method, comprising:
acquiring, from a first camera, a first target image of a target scene captured by the first camera;
determining, based on the first target image, a probability of enabling a second camera to capture a second target image of the target scene; and
enabling the second camera to capture the second target image of the target scene based on the probability of enabling exceeding a first probability threshold.

2. The image acquisition method according to claim 1, further comprising:
generating, based on the first target image, movement trajectory information of a target object in the target scene; and
wherein the enabling the second camera step is further based on a similarity between a trajectory represented by the moving trajectory information and a trigger trajectory being greater than or equal to a predetermined similarity threshold.

3. The image acquisition method according to claim 1, further comprising:
determining positional information of a target object within a shooting range of the first camera;
determining, based on the positional information, a moment of enabling the second camera;
wherein enabling the second camera step is further based on the moment of enabling.

4. The image acquisition method according to claim 1, further comprising:
determining a first number of occurrences of a reference object within a shooting range of the first camera during a first time period;
determining a second number of occurrences of the reference object moving from the shooting range of the first camera into a shooting range of the second camera during a second time period, wherein the first time period comprises the second time period, wherein a duration of the second time period is less than a duration of the first time period;
and wherein the first probability threshold is determined based on a quotient of the second number of occurrences and the first number of occurrences.

5. The image acquisition method according to claim 1, further comprising:
after enabling the second camera to capture the second target image of the target scene, determining whether a target object is included in the second target image captured by the second camera; and
after determining that the target object is included in the second target image, controlling the first camera to enter a standby hibernation mode.

6. The image acquisition method according to claim 1, further comprising:
after enabling the second camera to capture the second target image of the target scene, using a probability determination model to determine a target probability, wherein the target probability represents a probability that the first target image captured by the first camera and the second target image captured by the second camera contain a same target object; and
after determining that the target probability is less than a pre-determined second probability threshold and after determining that the first target image captured by the first camera and the second target image captured by the second camera comprise the same target object, employing the first target image and the second target image to continue to train the probability determination model.

7. The image acquisition method according to claim 1, further comprising:
after enabling the second camera, recognizing target objects in a plurality of target images captured by the first camera and the second camera;
classifying, based on the recognized target objects, the plurality of target images, wherein each class of target images comprise target images having a same target object;
causing display of each class of target images; and
after detecting a selection operation for a particular class of target images, splicing the particular class of target images in an order of moment of acquisition to generate a target video.

8. An image acquisition system, comprising:
a first camera;
a second camera; and
a server containing computer-readable instructions that, when executed by at least one processor of the server, cause:
acquiring a first target image of a target scene captured by the first camera;
determining, based on the first target image, a probability of enabling the second camera to capture a second target image of the target scene; and
enabling the second camera to capture the second target image of the target scene based on the probability of enabling exceeding a first probability threshold.

9. The image acquisition system according to claim 8, wherein the instructions, when executed by the at least one processor, further cause:
generating, based on the first target image, movement trajectory information of a target object in the target scene,
wherein enabling the second camera is further based on a similarity between a trajectory represented by the moving trajectory information and a trigger trajectory being greater than or equal to a predetermined similarity threshold.

10. The image acquisition system according to claim 8, wherein the instructions, when executed by the at least one processor, further cause:
determining positional information of a target object within a shooting range of the first camera;
determining, based on the positional information, a moment of enabling the second camera; and
wherein enabling the second camera is further based on the moment of enabling.

11. The image acquisition system according to claim 8, wherein the instructions, when executed by the at least one processor, further cause:
determining a first number of occurrences of a reference object within a shooting range of the first camera during a first time period;
determining a second number of occurrences of the reference object moving from the shooting range of the first camera into a shooting range of the second camera during a second time period, wherein the first time period comprises the second time period, and wherein a duration of the second time period is less than a duration of the first time period;
wherein the first probability threshold is determined based on a quotient of the second number of occurrences and the first number of occurrences.

12. The image acquisition system according to claim 8, wherein the instructions, when executed by the at least one processor, further cause:
after enabling the second camera to capture the second target image of the target scene, determining whether a target object is included in the second target image captured by the second camera; and
after determining that the target object is included in the second target image, controlling the first camera to enter a standby hibernation mode.

13. The image acquisition system according to claim 8, wherein the instructions, when executed by the at least one processor, further cause:
after enabling the second camera to capture the second target image of the target scene, using a probability determination model to determine a target probability, wherein the target probability represents a probability that the first target image captured by the first camera and the second target image captured by the second camera contain a same target object; and
after determining that the target probability is less than a pre-determined second probability threshold and after determining that the first target image captured by the first camera and the second target image captured by the second camera comprise the same target object, employing the first target image and the second target image to continue to train the probability determination model.

14. The image acquisition system according to claim 13, wherein the instructions, when executed by the at least one processor, further cause:
after enabling the second camera, recognizing target objects in a plurality of target images captured by the first camera and the second camera;
classifying, based on the recognized target objects, the plurality of target images, wherein each class of target images comprise target images having a same target object;
causing display of each class of target images; and
after detecting a selection operation for a particular class of target images, splicing the particular class of target images in an order of moment of acquisition to generate a target video.

15. An electronic device, comprising:
one or more processors, and
memory having executable instructions that, when executed by the one or more processors, cause the electronic device to:
acquire a first target image of a target scene captured by a first camera;
determine, based on the first target image, a probability of enabling a second camera to capture a second target image of the target scene; and
enable the second camera to capture the second target image of the target scene based on the probability exceeding a first probability threshold.

16. The electronic device according to claim 15, wherein the instructions, when executed by the one or more processors, cause the electronic device to:
generate, based on the first target image, movement trajectory information of a target object in the target scene; and
enable the second camera further based on a similarity between a trajectory represented by the moving trajectory information and a trigger trajectory being greater than or equal to a predetermined similarity threshold.

17. The electronic device according to claim 15, wherein the instructions, when executed by the one or more processors, cause the electronic device to:
determine positional information of a target object within a shooting range of the first camera; and
determine, based on the positional information, a moment of enabling the second camera,
wherein the second camera is enabled at the moment of enabling.

18. The electronic device according to claim 15, wherein the instructions, when executed by the one or more processors, cause the electronic device to:
determine a first number of occurrences of a reference object within a shooting range of the first camera during a first time period; and
determine a second number of occurrences of the reference object moving from the shooting range of the first camera into a shooting range of the second camera during a second time period, wherein the first time period comprises the second time period, and wherein a duration of the second time period is less than a duration of the first time period,
wherein the first probability threshold is determined based on a quotient of the second number of occurrences and the first number of occurrences.

19. The electronic device according to claim 15, wherein the instructions, when executed by the one or more processors, cause the electronic device to:
after enabling the second camera to capture the second target image of the target scene, determine whether a target object is included in the second target image captured by the second camera; and
after determining that the target object is included in the second target image, control the first camera to enter a standby hibernation mode.

20. The electronic device according to claim 15, wherein the instructions, when executed by the one or more processors, cause the electronic device to:
after enabling the second camera to capture the second target image of the target scene, use a probability determination model to determine a target probability, wherein the target probability represents a probability that the first target image captured by the first camera and the second target image captured by the second camera contain a same target object; and
after determining that the target probability is less than a pre-determined second probability threshold and after determining that the first target image captured by the first camera and the second target image captured by the second camera comprise the same target object, employ the first target image and the second target image to continue to train the probability determination model.
